(19) United States
(12) Patent Application Publication
(10) Pub. No.: US 2014/0169967 A1
(43) Pub. Date: Jun. 19, 2014

(54) HELICOPTER WITH ROTOR BLADE LOAD CONTROL METHOD AND DEVICE

(71) Applicant: John Anthony Wilkins, Turin (IT)

(72) Inventor: John Anthony Wilkins, Turin (IT)

(73) Assignee: Bluebirds Technology LLC, Cleveland, OH (US)

(21) Appl. No.: 14/124,943

(22) PCT Filed: Jun. 11, 2012
(86) PCT No.: PCT/US2012/041900

§ 371 Date: Dec. 9, 2013

Related U.S. Application Data
(63) Continuation-in-part of application No. 13/492,326, filed on Jun. 8, 2012, now abandoned.
(60) Provisional application No. 61/494,888, filed on Jun. 9, 2011.

(51) Int. Cl. B64C 27/54

(52) U.S. Cl. CPC B64C 27/54
USPC 416/31; 416/218; 416/170 R; 416/147

(57) ABSTRACT

Methods and devices are described for reducing the torque and the level of vibration on a helicopter rotor blade by maintaining a constant lift and constant (low) drag on each section of the blade throughout the entire revolution. A rotor system includes a trackway defining a continuous travel circuit, truck members operatively coupled with the trackway wherein the truck members are selectively translatable along the travel circuit, prime movers operatively coupled with the truck member for selectively moving the truck members along the travel circuit, elongate rotor blades having proximal ends operatively coupled with the truck members and opposite free distal ends wherein the rotor blades are carried with the truck members along the travel circuit thereby generating an upward force for lifting associated load-carrying vehicles. The methods and apparatus allow the rotor blades and the transmission to be significantly lighter and easier to manufacture.

### CROSS REFERENCE TO RELATED APPLICATIONS

This application claims priority to PCT Patent Application No. PCT/US2012/041900 filed Jun. 11, 2012, which claims priority to and is a continuation-in-part of U.S. patent application Ser. No. 13/492,326, filed on Jun. 8, 2012, which claims priority to U.S. Provisional Patent Application No. 61/494,888, filed on Jun. 9, 2011.

### FIELD

The following embodiments disclosed and described herein relate generally to rotorcraft and components thereof and, more particularly, to a method and rotorcraft apparatus for controlling the forces acting on the rotor blades of a helicopter or other rotary winged vehicle.

### BACKGROUND

Helicopters and other rotary winged vehicles include one or more main rotors each having a plurality of rotor blades. The rotor blades are typically rotatably driven either by a central drive mechanism, or by jets located on each blade, usually at an outboard station of the blade.

There are a number of problems with prior art rotor blades and their corresponding blade control systems, which tend to limit the type of missions in which their owners can effectively and efficiently employ them.

One of the main problems associated with helicopters is the amount of vibration and noise generated by rotation of the main rotor blades. The noise can hamper the crewmembers' ability to communicate, and the level of vibration causes discomfort for passengers and crew. On medevac flights, a high level of vibration can cause additional pain and suffering for the patient.

The level of vibration also causes fatigue damage to structural components of the helicopter. In a prior art blade, a 1-mm crack can grow to 40 mm or more in the span of a single flight. For this reason, some original equipment manufacturers (OEM's) require that each blade undergo an ultrasound or eddy current inspection every 60-100 flight hours, and that the blade be retired after only 800 hours total time since new. In addition, many parts of the fuselage structure must be over-designed in order to withstand this vibration.

The forces acting on a section of the rotor blade are fairly large (up to 45 times the weight of the section) and vary significantly over the course of a single revolution of the rotor, even in hover on a calm day.

The pilot, thru the flight control system, controls the net lift of the rotor blade only on a macroscopic scale, usually by controlling the pitch angle of the root section of the blade. On a smaller scale, the lift on a given section of the blade goes pretty much uncontrolled.

The instantaneous value of the lift on a thin, mid-span section of the advancing blade, when the blade is at a position 90 degrees relative to the flight path of the vehicle supported by the rotating blade, might be calculated as 40 Newtons on paper. But in practice, however, it might be 50 Newtons on the first blade, 30 Newtons on the successive blade, 55 Newtons on the third blade, and so on. On the retreating blade, the variation in lift is even more dramatic.

The major helicopter OEM's have invested significant sums researching higher harmonic control, but the methods so far investigated do not address this and other fundamental problems.

According to a senior researcher at NASA Ames, today's supercomputers are unable to accurately model the aeroelastic behavior of the prior art rotor blade and the unsteady flows it operates in. The consensus seems to be that any significant reduction of noise and vibration in prior art rotor systems will not occur for many years yet.

As can be seen, there exists a need in the art for a system and method for positive, direct, and tight control of the lift and drag on each section of the rotor blade. In addition, there exists a need in the art for a lightweight rotor blade and lightweight rotor system, and which is easy to construct and obviates the need for a long sequence of complex manufacturing processes with extremely tight tolerances. There is also a need in the art for a rotor system and method which permits a lighter and less complex transmission to be employed.

### BRIEF SUMMARY OF THE EMBODIMENTS

In accordance with various embodiments of the claimed invention herein, methods and apparatus are provided for addressing the above-described needs and others wherein about 25% (circa) of the outboard (radially outwardly) portion of a rotor blade generates about 97% (circa) of the lift, and wherein each of the rotor blades are divided into three or more radially extending end to end sections or portions, wherein the local angle of attack of each section or portion is selectively modulated, and other parameters thereof are controlledly modified, to maintain enhanced lift on each of the individual sections at a substantially constant desired value throughout the revolution of the rotor blade, regardless of rapid changes in pitch rate or roll rate, however induced, clear air turbulence, etc.

One objective in modulating the angle of attack of the individual sections is to control the individual sections as much as possible to be disposed or positioned within a desired range of values for which the drag coefficient of the section is at a minimum (the so-called “drag bucket”).

Accordingly, overall, two or more blades, with the root section of each blade located at a distance D from the center of the rotor system, much farther outboard radially outwardly than in prior rotor systems, at least 0.12*(rotor diameter) and up to 0.47*(rotor diameter) from the center of the rotor is provided.

In particular, methods and devices are described herein for reducing the torque and the level of vibration on a helicopter rotor blade by maintaining a constant lift and constant (low) drag on each section of the blade throughout the entire revolution. In spite of large variations in the magnitude and angle of the relative wind, control effectors work to modify the circulation about the section, such that the lift on that section is maintained within a narrow band around a value that can be set prior to takeoff, or commanded by a flight control computer. A rotor system includes a trackway defining a continuous travel circuit, truck members operatively coupled with the trackway wherein the truck members are selectively translatable along the travel circuit, prime movers operatively coupled with the truck member for selectively moving the truck members along the travel circuit, elongate rotor blades having proximal ends operatively coupled with the truck members and opposite free distal ends wherein the rotor blades are carried with the truck members along the travel circuit thereby generating an upward force for lifting associated load-carrying vehicles. The method allows the rotor blades and the transmission to be significantly lighter and easier to manufacture.

In addition, a rotor system for lifting an associate load-carrying vehicle upwardly is disclosed. The rotor system includes an elongate central shaft member defining a central longitudinal axis L therealong, a ring-shaped beam member operatively coupled with the central shaft member and being disposed in a plane substantially perpendicular to the central longitudinal axis L, and a plurality of elongate blade members each having a proximal end operatively coupled with the ring-shaped beam member and an opposite free distal end, wherein the central shaft member is arranged to be selectively driven into rotation about the central longitudinal axis L whereby the plurality of blade members coupled with the ring-shaped beam member are urged into motion along a circular path thereby generating an upward force for lifting the associated load-carrying vehicle. In one form of an example embodiment, the central shaft member is arranged to be selectively driven into rotation about the central longitudinal axis L by an operatively associated prime mover coupled with the central shaft member. In another form of an example embodiment, the central shaft member is arranged to be selectively driven into rotation about the central longitudinal axis L by one or more operatively associated prime movers coupled with a corresponding one or more of the plurality of blade members.

In addition, a rotor system according to the above is provided in which the rotor blade, without being divided into sections, rotates in its entirety about an axis extending outward radially from the truck, and parallel to or nearly parallel to, the spar axis. The rotation may be suitably effected by a hydraulic rotary actuator located on the truck and supplied by an electrically driven hydraulic pump, also located on the truck. In addition, a rotor manufacture.

Further, a rotor system according to the above is provided in which only the aft half (30% to 54%) of the rotor blade section rotates trailing edge up or trailing edge down.

Still further, a rotor system according to the above is provided in which an external aero surface of a flap, driven by the FCC, provides additional torque in order to assist the main motor/actuator housed inside the blade section.

Yet still further a rotor system according to the above is provided in which an addition of a solar photovoltaic array in the top of each panel is provided for generating power for essential services during failure of the primary electrical system, and wherein up to 70% of the power required for the motor that pushes the rotor blade around the trackway.

### BRIEF DESCRIPTION OF THE SEVERAL VIEWS OF THE DRAWINGS

FIG. 1 is a perspective view of a rotor system for lifting an associated load-carrying vehicle upwardly in accordance with a first example embodiment;

FIG. 2 is a cross-sectional view illustrating a truck and trackway portion of the rotor system of the first example embodiment taken along line 2-2 of FIG. 1;

FIGS. 3a and 3b are cross-sectional views illustrating internal components of a rotor blade portion of the rotor system of the first example embodiment in various positions and taken along line 3-3 of FIG. 1;

FIG. 4 is an elevated perspective view illustrating the truck and trackway portion of the rotor system of the first example embodiment in partial phantom and taken along line 4-4 of FIG. 2;

FIG. 5 is a perspective view of a cross-section of a non-solid ring-shaped beam used in association with the rotor system if FIG. 1 for lifting an associated load-carrying vehicle upwardly in accordance with the first example embodiment;

FIG. 6 is a cross-sectional view illustrating internal components of a rotor blade portion of the rotor system of the first example embodiment taken along line 6-6 of FIG. 1;

FIG. 7 is an axially directed perspective view of a rotor system for lifting an associated load-carrying vehicle upwardly in accordance with a second example embodiment;

FIG. 8 is a perspective view of a spar member in accordance with an alternative example embodiment;

FIG. 9 is a perspective view of a rotor system for lifting an associated load-carrying vehicle upwardly in accordance with a first example embodiment;

FIG. 10 is a cross-sectional view of a portion of a truck and trackway portion similar to that shown in FIG. 2 in accordance with a further example embodiment;

FIG. 10a is a cross-sectional view of a portion of the system shown in FIG. 10 taken along line A-A thereof;

FIG. 11 is a cross-sectional view illustrating internal components of a rotor blade portion of the rotor system of a further example embodiment taken along line 6-6 of FIG. 1;

FIGS. 12a and 12b are front elevational and top plan views, respectively illustrating a multi-bladed elongate rotor blade construction in accordance with a further example embodiment;

FIG. 13 is a schematic cross-sectional view illustrating a rotor blade portion of a rotor system of the further example embodiment of FIGS. 12a and 12b illustrating an overall profile of the rotor blade portion;

FIG. 14 is schematic of a control system in accordance with an example embodiment;

FIG. 15 is a top perspective view of a single rotor blade coupled with a truck member and a trackway in accordance with an embodiment;

FIG. 16 is force chart illustrating forces generated by the rotor system in accordance with the example embodiments herein;

FIG. 17a is hardware schematic of a system for controlling the embodiments herein in accordance with the algorithm and function thereof as illustrated;

FIG. 17b is a chart of the system control, set point, and feedback signals and variables used in a control method implemented by the control system of FIG. 17a; and,

FIG. 17c is a polar chart illustrating a drag bucket beneficial for reducing vibrations in accordance with the example embodiments.

The accompanying drawings, which are incorporated in and constitute a part of this specification, illustrate several embodiments of the claimed invention and together with the description, serve to explain the principles of the claimed invention.

### DETAILED DESCRIPTION OF THE EMBODIMENTS

In the following description of the example embodiments of the claimed invention reference is made to the accompanying figures which form a part thereof, and in which is shown, by way of illustration, exemplary embodiments illustrating the construction and principles of the embodiments and how they are practiced. Other embodiments will be utilized to practice the claimed invention and structural and functional changes will be made thereto without departing from the scope of the claims herein.

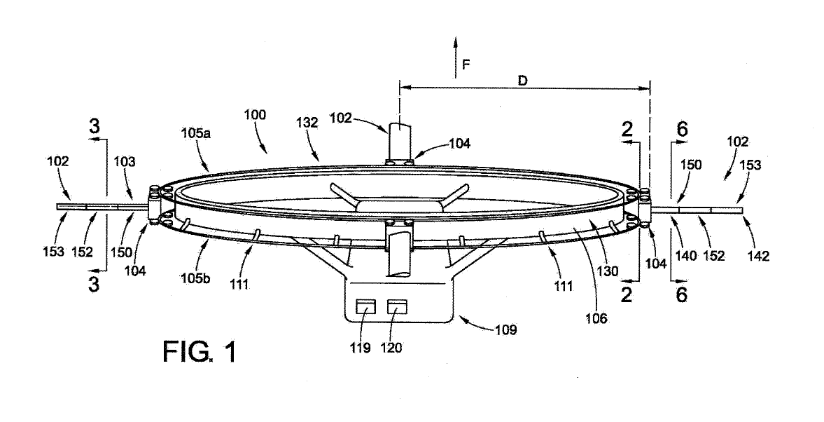

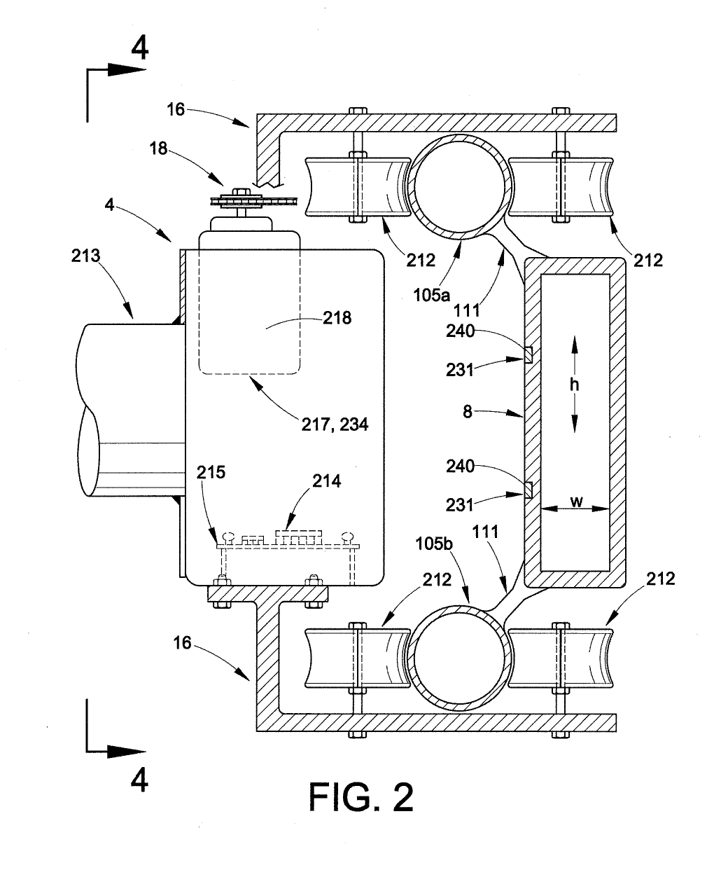

FIG. 1 shows a rotor system 100 for lifting an associated load-carrying vehicle 109 upwardly in accordance with a first example embodiment. With reference now to that Figure and to FIG. 2, the rotor system 100 includes a trackway 130 defining a continuous travel circuit 132, a truck member 104 operatively coupled with the trackway 130, the truck member 104 being selectively translatable along the travel circuit 132 shown in the example embodiment as a circle, a prime mover 217 (FIG. 2) shown as an electric motor 218 in the example operatively coupled with the truck member 104, the prime mover 217 selectively moving the truck member 104 along the travel circuit 132, one or more elongate rotor blades 102 each having a proximal end 140 operatively coupled with the truck member 104 and an opposite free distal end 142, wherein the rotor blade 102 is carried with the truck member 104 along the travel circuit 132 thereby generating an upward force F for lifting the associated load-carrying vehicle 109. In addition, the rotor system 100 of the example embodiment further includes a position sensor 231 (FIG. 2) configured to generate a signal representative of a position of the truck member 104 relative to the trackway 130, and a controller 119 configured to receive the signal representative of the position of the truck member 104 relative to the trackway 130 and to determine a position of the truck member 104 relative to the continuous travel circuit 132 in the air vehicle reference plane.

The root section 103 of each rotor blade 102 is affixed, not to a central rotating shaft, but to a corresponding truck member 104. The truck member 104 is configured to slidably translate along a pair of axially spaced apart rails 105a and 105b in the continuous travel circuit 132. The rails 105a and 105b preferably have an outer diameter of approximately 1.5 inch, and are preferably made of high-strength steel or any other suitable materials. Other metals or materials can be used for the rails 105a and 105b, depending on the mission and other requirements, but steel is preferable for reasons described in greater detail below.

The pair of axially spaced apart rails 105a and 105b are held in place by a ring-shaped beam 106. The rails are operatively slidably connected with the beam 106 by a set of rod members 111 substantially as shown. The diameter of the beam 106 in the example embodiment illustrated is at least 0.15*Rotor_Diameter D, and at most, 0.93*Rotor_{—}Diameter D. In other forms and examples, the diameter of the beam 106 may, as necessary or desired, be at least 0.3*Rotor_Diameter D, but not less than 7.0 feet, and at most, 0.9*Rotor_Diameter D. A cross section 108 of the beam 106 has a height of about 0.05 to 0.3 times the diameter of the ring-shaped beam 106 and a width of about 0.1-0.8 times its height. The ring-shaped beam can be made from a variety of materials used in the aerospace industry for primary structure, such as carbon fiber, aluminum, titanium, or kevlar, according to variables and design considerations stemming from the end users' primary mission and operating environment. In many applications, carbon fiber is the preferred choice, since it provides the lowest weight for the set of hardover conditions described below. The associated payload 109 can be either rigidly attached to the beam 106, or suspended from the beam by heavy-duty chains (not shown).

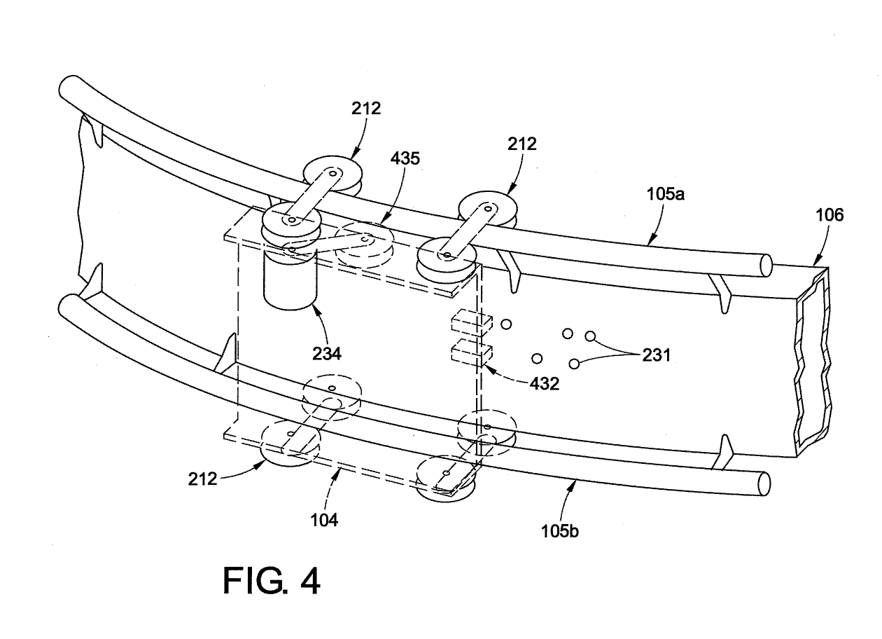

The upper rail 105a and lower rail 105b are about 0.7 to 3.0 feet apart in the example embodiment shown. The truck assembly 104 provides an interface between the rotor blades 102 and the upper and lower rails 105a, 105b. In its preferred form, the truck has a minimum of six wheels 212, three per rail, but it is preferable to use four per rail, for a total of eight such as illustrated for example in FIG. 4. Separation between the trucks is maintained by carbon fiber rods 215. Each rotor blade 102 is divided into three or more sections 150, 152, 154. Each section 150, 152, 154 is free to rotate about a radially extending spar member 213 independently of the other sections.

Each truck assembly 104 is equipped with logic including a non-transient memory in the preferred form of at least one microprocessor 214 that is used to communicate with the plurality of sensors (not shown) and control effectors (not shown) distributed along the rotor blades 102. In the example illustrated, the microprocessor 214 communicates with a central flight control computer 119 and/or logic including a non-transient memory in the preferred form of a maintenance computer/flight data recorder 120.

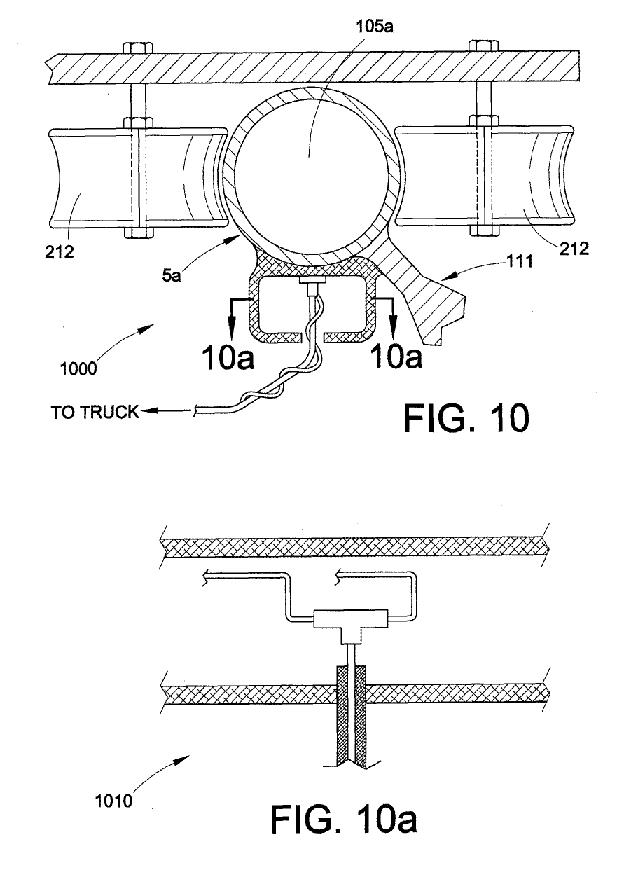

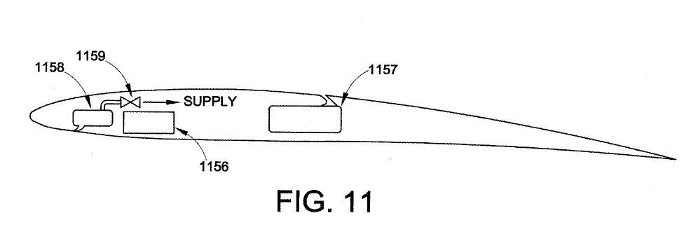

The flight control computer 119, if installed, uses the information and other signals received from the sensors in the rotor blade, and from the two preceding blades, to calculate and constantly update the required changes to the control effectors, such that the lift on each section of each blade remains fairly constant. Transmission of sensor data and control signals between the truck and the flight control computer is, in accordance with an example wireless and, in accordance with another example is provided by means of a slip ring arrangement 1000, 1010 such as shown, for example, in FIGS. 10 and 10a.

Sensors 231 in the form of a series of magnets 240 are embedded in the ring-shaped beam 106, and three or more Hall Effect Sensors 432 (FIG. 4) are attached to each truck assembly 104. The sensors 231 in the form of a series of magnets 240 are embedded in the ring-shaped beam 106 in particular arrangements so that the waveform generated by the Hall Effect sensors 432 as the truck member 104 translates relative thereto is unique to each section of the ring-shaped beam, which allows the processor 11 to establish the position of the truck members within the fuselage frame of reference.

If each rotor blade 102 is self-propelled (the preferred method) and jets are not employed, then each truck must be equipped with a device that allows the truck to propel itself along the rails. The device could include an electric motor 234 turning a drive wheel 435 as shown in FIG. 4, with the energy supplied by a. electrical cables embedded in each rail (see FIG. 10.a) or b. Lithium-Ion battery packs contained in the truck and/or the root section of the blade, or c. Solar PV cells such as those made by SunPower. Alternatively, the drive wheel 435 could be connected to a small internal combustion engine, running on diesel or CNG or another fossil fuel, or on compressed hydrogen. In this case, a small fuel tank could be affixed to the truck, or it could form an integral part of the spar of the rotor blade.

The truck members 104 are equipped with sensors (not shown) that measure the instantaneous net force acting on the rotor blade 102 in a direction normal to the path of the rails, and in a direction parallel to their path, which is resolved into lift and drag parameters, for use by the flight control computer.

One of the keys to minimizing vibration is to start with a rotor blade that has a high aspect ratio, 12:1 or greater, and then divide the blade into three or more sections 150, 152, 154, and allowing each section of the set of sections S to rotate about the spar 213 in order to controlledly maintain lift on the section constant, despite rapid changes in the magnitude and direction of the relative wind at the section.

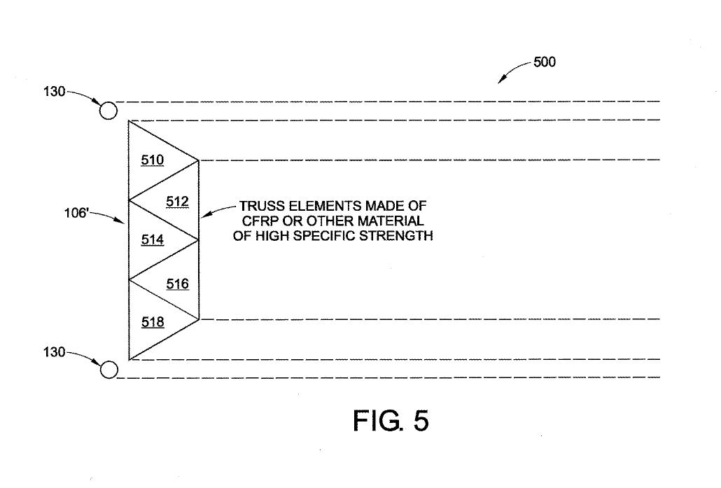

With reference next to FIG. 5, a cross-section of non-solid ring-shaped beam 500 is illustrated. The non-solid ring-shaped beam 500 is particularly useful for slow speeds such as, for example, in hauling logs to a lumber mill, etc. While solid beams do not present a problem, the non-solid ring-shaped beam 500 as illustrated in FIG. 5 advantageously provides considerably less drag at higher speeds than solid beams. In FIG. 5, the two small circles are the trackway 130 and the five triangles 510-518 represent the cross-section of one embodiment of the ring-shaped beam 106′ because even though FIG. 1 shows the beam 106 as being of a solid conformation, such construction is not aerodynamically efficient. In practice therefore, the beam 106′ is preferably a truss-like structure made of many CFRP rods substantially as shown.

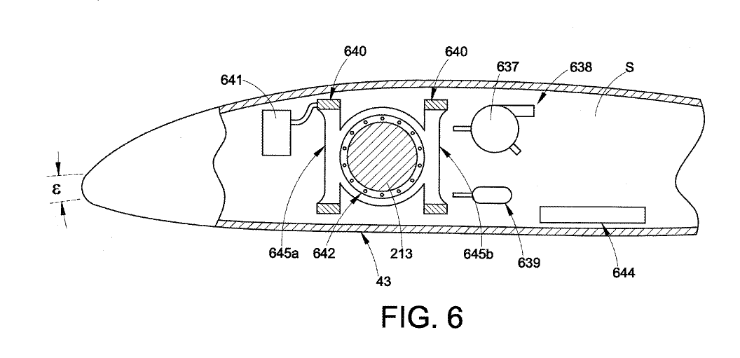

As shown best in FIG. 6, a pair of ball bearings 642 are disposed between the blade sections 150, 152, 154 and the spar 213. In one preferred form, the pair of ball bearings 642 disposed between the blade sections 150, 152, 154 and the spar 213 are permanently attached with the spar 213.

The inner race of each bearing is fixed to the spar, and the outer race is clamped by two halves 645a and 645b of a housing. The upper half 645a is fixed to the primary structure of the section S illustrated, and two or more strain gages 640 measure the forces exerted by the section on the spar. The signals generated by strain gages 640 are passed thru a signal conditioner 641 prior to being sent to the in-section microprocessor 119 or to the flight control computer 120.

The relative angular position ε between the spar and the blade section can be controlled using a variety of means. In one preferred method, the relative angular position ε between the spar and the blade section is controlled, for example, by an electric motor 637. One or more rotary variable differential transformers 639 measure this relative angle and provide feedback to the subsystem controlling the speed and direction of the motor 637. A tachometer 638 provides feedback on angular velocity of the motor's shaft.

Alternatively, the angular position of the section relative to the spar ε may be passively controlled. For example, one could locate the spar well forward of the aerodynamic center, and employ a torsional spring such that any increase in lift beyond the setpoint causes the section to rotate nose-down, reducing the section angle of attack and cancelling the original increase (disturbance) in lift. The setpoint could be adjusted on the ground using a screwdriver or other mechanical means, or be caused to vary (slowly) with phase of flight.

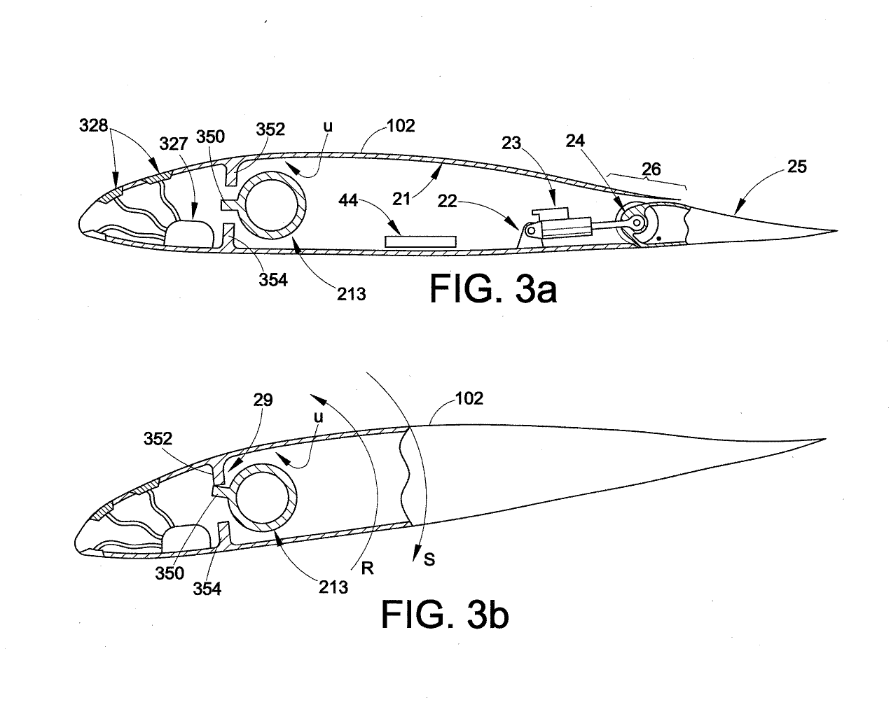

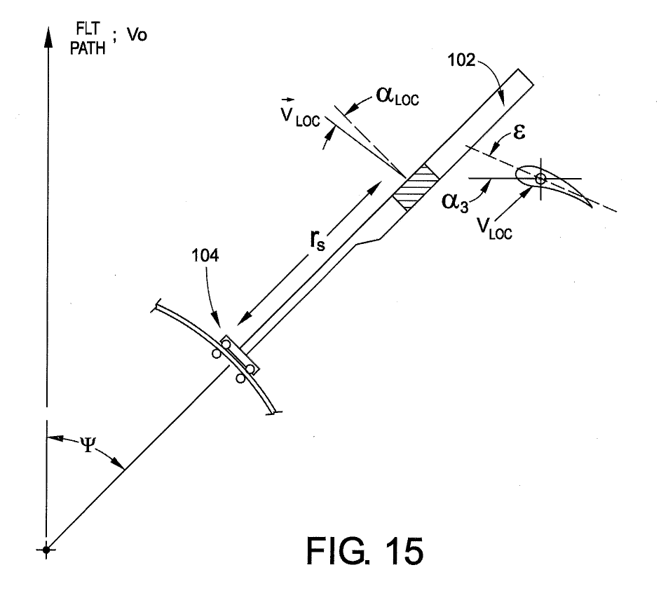

In the former case, using a PID controller and a small electric motor to control the angle, fairly good performance can be achieved using only the sensors which are located within that section: coarse control through (local) angle of attack vane 46, pitot tube 47, flush air data sensors (327, 328 of FIG. 3) as inputs to the on-section microprocessor, and fine control using strain gage measurement of the normal force (lift) such as shown, for example in FIG. 15. As shown in the Figure, the spar member 213 carries at least one travel limiter member 350 for selected abutment with corresponding upper and lower hard stop members 352, 354 respectively carried internally by the elongate rotor blade members 102. The hard stop members 352, 354 limit rotational movement of the elongate rotor blade member 102 relative to the spar member 213. It is to be appreciated that FIG. 3a illustrates an example of an elongate rotor blade member 102 in a mid-travel position relative to the spar member 213 wherein the at least one travel limiter member 350 is spaced from contact with either of the upper or lower hard stop members 352, 354. It is further to be appreciated that FIG. 3b illustrates an example of an elongate rotor blade member 102 in an end of travel position relative to the spar member 213 wherein the at least one travel limiter member 350 is spaced from contact with the lower hard stop member 354 and is in abutting contact with the upper hard stop member 352, thereby limiting further rotation of the elongate rotor blade member 102 relative to the spar member 213 in a first direction R. However, the elongate rotor blade member 102 remains free to rotatably move relative to the spar member 213 in a second direction S opposite the first direction R.

In order to minimize vibration, the lift generated on a given blade section preferably follows as close as possible the ideal lift for the flight conditions, which consists of a mean lift component and a cyclic (once per rev) lift component. Disturbances are preferably compensated for as smoothly as possible. In accordance with the example embodiment, at any point in time, the lift generated by a given section of a given blade is determined as follows:

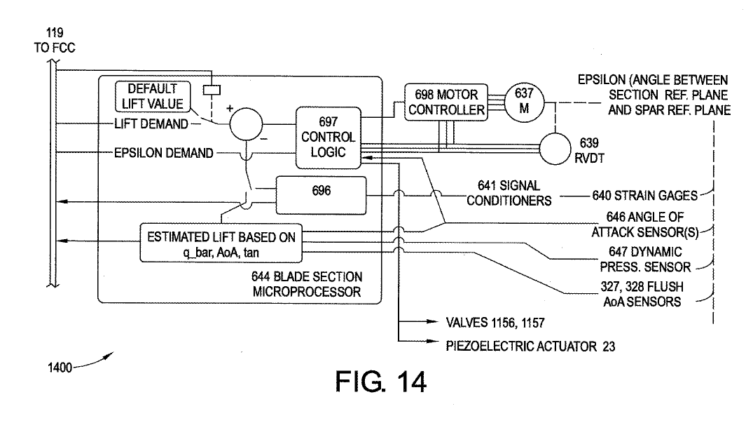

a. The blade section microprocessor 644 receives a position command <epsilon_demand> as well as a force command <lift_demand> from the flight control computer 119. (see FIG. 14)
In case of loss of communication with the FCC, the blade section microprocessor will default to a lift value determined by the air vehicle designer, nominally 1/N times the vehicle empty weight, where N is the total number of blade sections.

The section microprocessor will drive the motor (or other control effector) in order to meet the <epsilon_demand> as long as the FCC determines that the epsilon loop is working properly, because this loop includes the output of the Kalman filter 1800 and yields the optimum response to atmospheric disturbance.

If the FCC determines that the <epsilon_demand> loop is not working properly, the section microprocessor will use feedback from the strain gages 641 to follow the <lift_demand> signal. The output of the strain gages will be passed thru a notch filter which takes into account blade spar natural frequencies, and a hysterisis (set by the air vehicle designer but not less than 2 kg) to avoid excessively taxing the motor 637.

b. The FCC commands to the various sections of a rotor blade are such that
at any point in time, the difference in force between two adjacent blades is minimized (order of 3 kg or less) the total lift demand for that rotor blade is met
all sections are operating with a deflection that puts the local angle of attack in the drag bucket.

c. Each blade section is self-protecting
First, there is a mechanical hard stop for trailing edge down deflection (352) as well as for trailing edge up deflection (354) which limit the lift coefficient, according to the air vehicle designer's requirements, but on the order of +0.63 and −0.15 protecting
Second, there is a software limit embedded in the microprocessor which varies as a function of phase of flight.

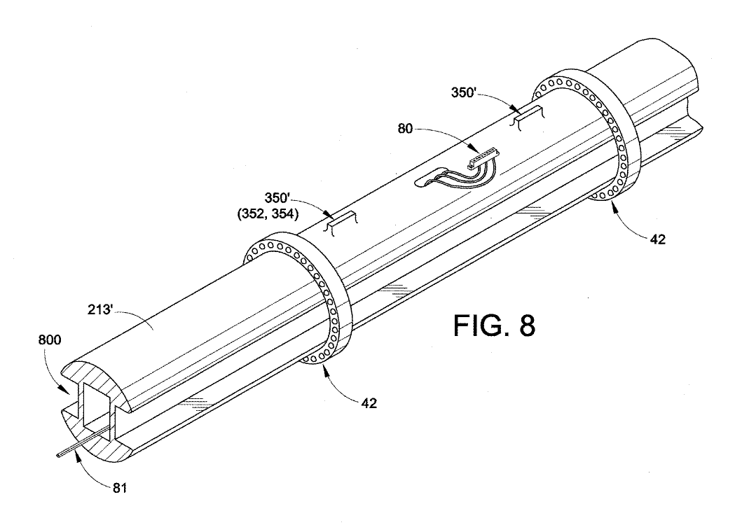

FIG. 8 shows a further example embodiment of a spar member 213′ having an overall flattened cross-sectional configuration 800 wherein a pair of travel limiter members 350′ are carried on an upper portion of the spar member. In this example, the upper and lower hard stop members 352, 354 shown in FIGS. 3a and 3b are replaced or otherwise substituted with fore and aft stop members (not shown) carried or otherwise disposed on the underside U (FIG. 3) of the elongate rotor blade member 102 for equivalently limiting rotational movement of the elongate rotor blade member (not shown in FIG. 8) relative to the spar member 213′.

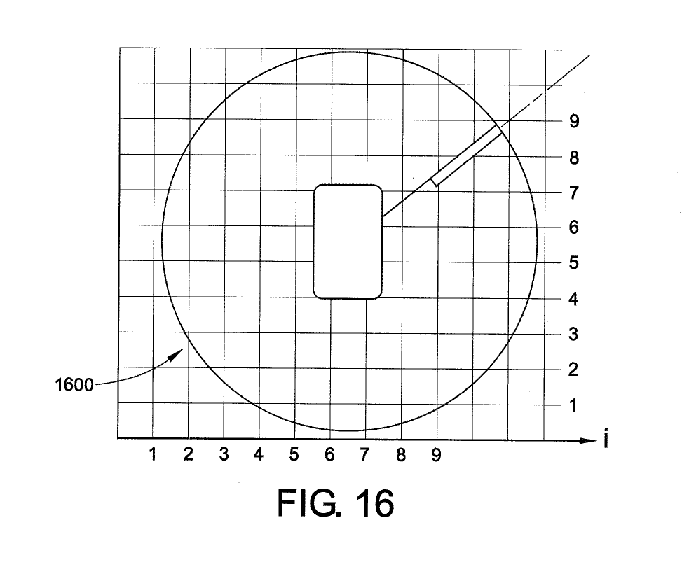

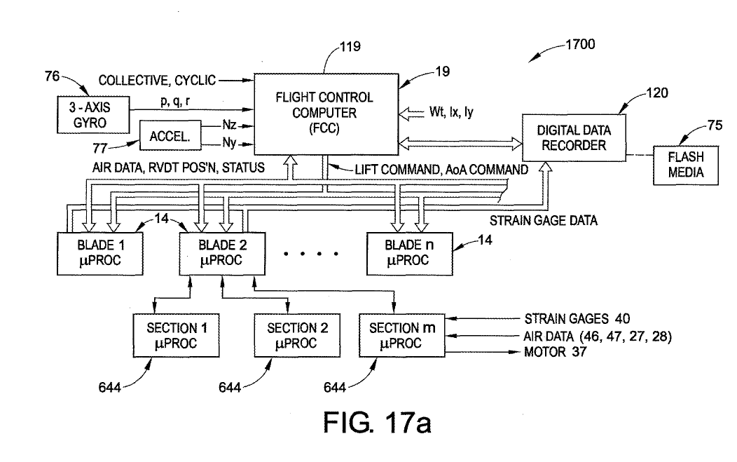

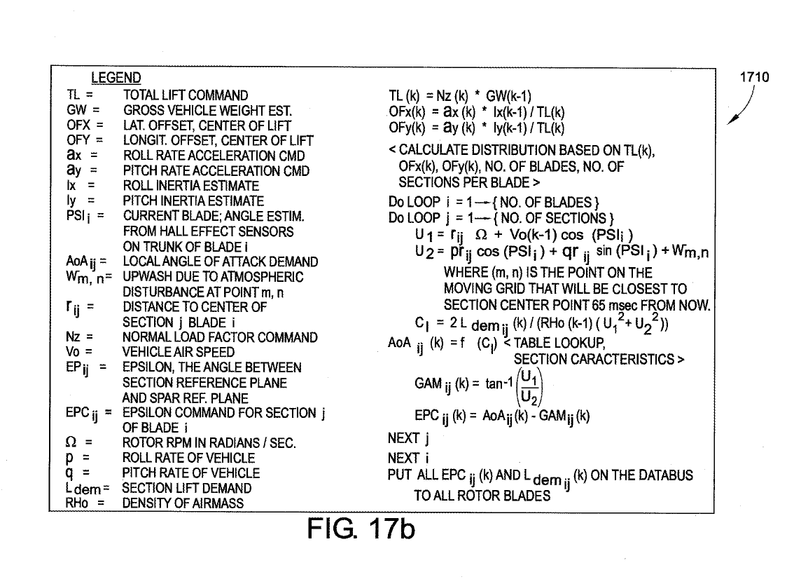

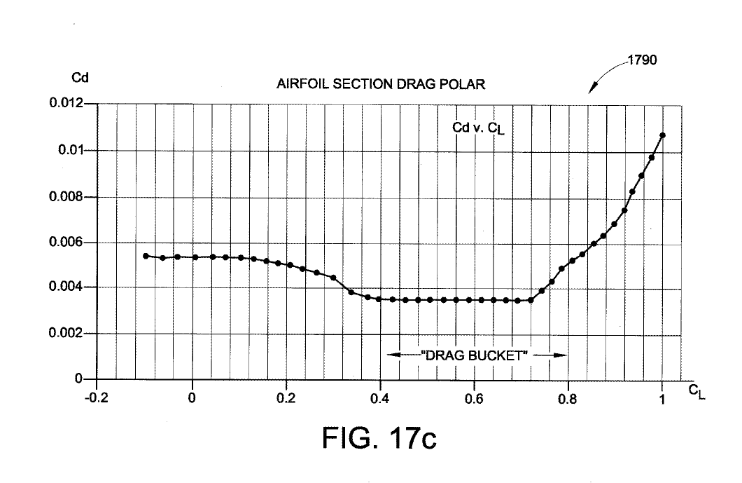

Even better performance can be obtained when the on-section microprocessor receives additional inputs from a central flight control computer. The primary reason for this is that the flight control computer can “stay ahead” of the blade, in the sense that it can fairly well predict the three components of the relative wind (spar-centered coordinate system) that section S will see when the rotor blade gets to ψ based on the data coming from sensors mounted on the corresponding section of the two preceding rotor blades such as shown for example in FIGS. 16 and 17. In other words, instead of “waiting” for the normal load on the section to rise above or fall below the target value by 3 percent, and then reacting to cancel the disturbance, the flight control computer starts ε going in the right direction several milliseconds in advance.

Electrical power (24 volt) for the sensors, actuators, and microprocessor in each section comes from the truck 104 via a wiring harness in the spar. Preferably, in the example embodiment, a multi-pin connector such as an 11-pin connector joins the section harness to the spar harness. The truck receives its power either from bus bars located on the underside of each rail such as shown, for example, in FIG. 10.a or from a small generator running off the internal combustion engine used to turn the drive wheel(s) of the truck.

In addition, the rotor blade spar/truck interface might be equipped with a mechanism that permits the sweep (angle between the blade leading edge and a plane tangent to the two rails) to be varied between flight phases. While one goal of the present invention is to allow much lower rotor RPM, it does not preclude the possibility of tip speeds going into the transonic regime, and in that case, the designer might find a need for positive sweep.

For certain applications, the air vehicle designer might want a rotor blade which is very light, a small fraction of the Design Limit Load of the blade. Very light weight, however, can detract from the performance of the system described above. The following presents a couple of ways the stiffness of the rotor blade can be significantly increased, in a way that is compatible with the present invention, and widen the design space as far as possible for the rotorcraft designer.

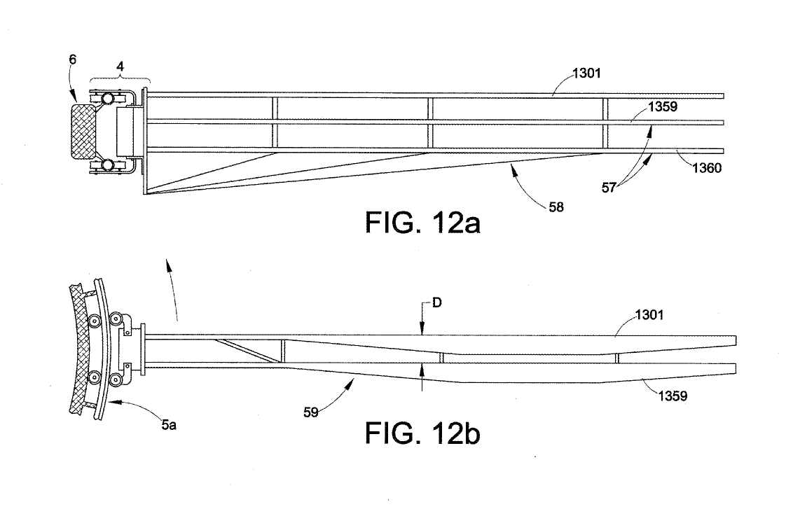

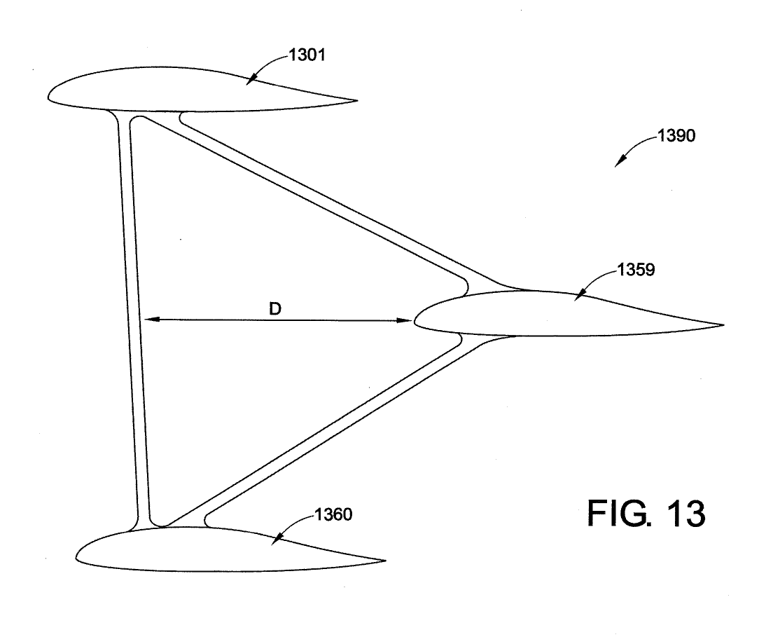

The simplest way is to replace the single blade with two blades of shorter chord and higher aspect ratio 1357, as shown, for example in FIGS. 12 and 13 one can think of this as the “biplane” configuration. In addition, the blade can be braced using lengths of Spectra© or some other high-strength fiber 1358 can be run from the lower surface of the lower wing to an anchor plate extending downwards from the truck. Shortening the chord has the additional advantage of lowering the Reynolds Number, which may yield a somewhat lower drag.

A configuration 1300 which provides very high stiffness in torsion is shown in FIGS. 12 and 13. Another blade or a second pair of blades 1359 is located a distance D aft of the first pair of blades 1360, 1361 and rigidly connected to the first pair. At first, this might seem like overkill, but it does allow the structural weight of the rotor blade to come down as low as 1.7% of DLL while taking full advantage of the present invention.

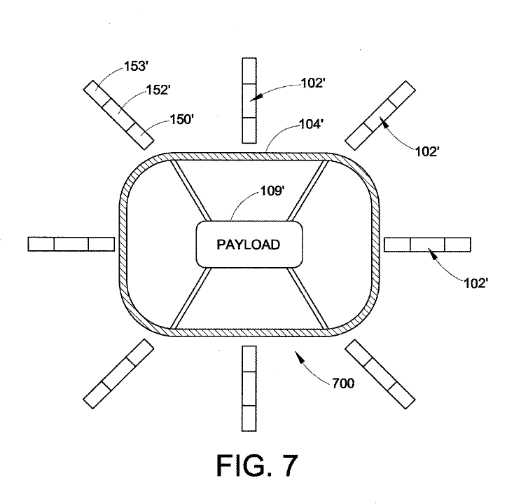

A key advantage provided by this first embodiment of the invention is that the pair of rails need not travel along a path which is perfectly circular, with respect to a reference frame bound to the fuselage. For example, a path with an oval or rectangular shape 700 becomes possible such as shown, for example, in FIG. 7. The pair of rails need not remain in a single plane, either. The ability to operate out of plane presents several advantages to the designer of the air vehicle.

An objective of the example embodiments is to eliminate the need for the swashplate and pitch links found in most prior art rotor systems. As an additional safety measure, however, there is the provision for adding a device which performs a function similar to that of a swashplate, as part of a backup system, in the event of multiple like failures of the system described herein.

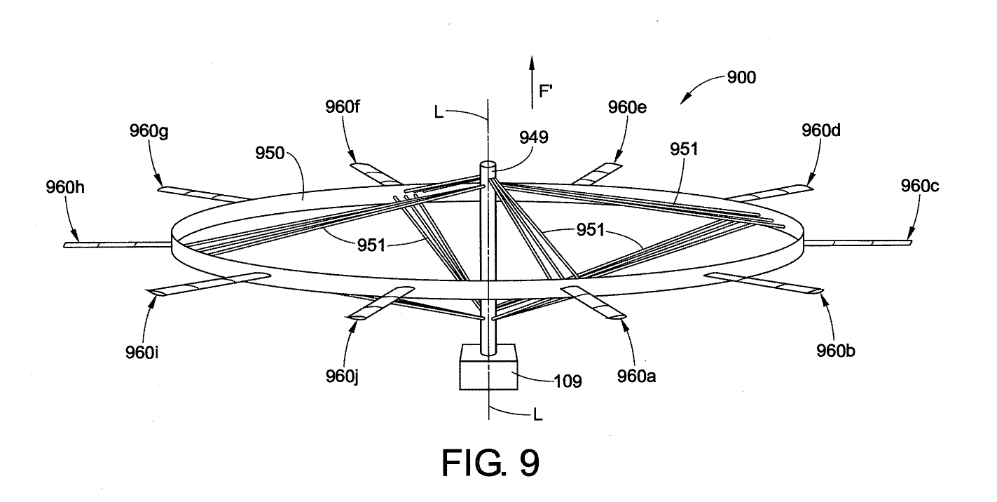

In addition, with the disclosed embodiments, it is no longer necessary to have a central driveshaft as found in prior art rotor systems, driven by one or more engines and a transmission. Prior art transmissions tend to be fairly heavy and expensive, and often they are located just a few inches above the passengers' heads. However, a means of retrofitting the drive system of an existing helicopter fleet so that they can take advantage of the present invention is described in greater detail below with reference to FIG. 9.

FIG. 14 is a schematic of a control system 1400 in accordance with an example embodiment.

FIG. 15 is a top perspective view of a single rotor blade 102 coupled with a truck member 104 and a trackway 130 in accordance with an embodiment.

FIG. 16 is force chart 1600 illustrating forces generated by the rotor system in accordance with the example embodiments herein.

FIG. 17a is hardware schematic of a system 1700 for controlling the embodiments herein in accordance with the algorithm and function thereof as illustrated.

FIG. 17b is a chart 1710 of the system control, set point, and feedback signals and variables used in a control method implemented by the control system of FIG. 17a.

FIG. 17c is a plot 1790 of blade section drag coefficient vs. section lift coefficient for one possible airfoil in accordance with an example embodiment.

FIG. 9 shows a rotor system 900 for lifting an associated load-carrying vehicle 109 upwardly in accordance with a second example embodiment. In this case, the ring-shaped beam 950 is fixed to a central shaft 949 by at least three lightweight structural elements or “spokes” 951 and is allowed to rotate. The rotor blades 952 are fixed to the ring-shaped beam. Rotary motion of the beam and rotor blades can be imparted by the central shaft (i.e. driveshaft) or the rotor blades might be self-propelled, for example, by means of jets mounted on each blade, whose thrust can be varied by the pilot thru the flight control computer.

The spokes 951 are designed such that they provide the required tensile strength but contribute less than 5% of the total lift of the rotor, and contribute less than 3% of the system torque. One possible cross-section 1200 for the spokes 951 is shown in FIG. 12, for example.

Even though the second embodiment doesn't provide some of the advantages that the first embodiment provides, such as non-circular paths for the blade root/truck, it does offer a couple of its own advantages. For example, lithium ion batteries might be carried within the ring-shaped beam. Diesel fuel might also be carried internally, but there might be challenges to maintaining an even weight distribution as fuel is burned.

In either case, the beam would have extra rotational inertia which is an aid in the event of auto-rotation.

Even if the central driveshaft is providing the torque to overcome the drag of the rotor blade, it is desirable to have the electrical power required to operate the sensors, actuators and microprocessors, generated locally to each blade.

With continued reference to FIG. 9, the rotor system (900′ of the illustrated example embodiment for lifting an associate load-carrying vehicle 109′ upwardly comprising, in particular, an elongate central shaft member 949′ defining a central longitudinal axis L′ therealong, a ring-shaped beam member 950′ operatively coupled with the central shaft member 949′ and being disposed in a plane substantially perpendicular to the central longitudinal axis L′, and a plurality of elongate blade members 960a′-960j′ each having a proximal end operatively coupled with the ring-shaped beam member 950′ and an opposite free distal end, wherein the central shaft member 949′ is arranged to be selectively driven into rotation about the central longitudinal axis L′ whereby the plurality of blade members 960a′-960j′ coupled with the ring-shaped beam member 950′ are urged into motion along a circular path thereby generating an upward force F′ for lifting the associated load-carrying vehicle 109′.

In an example embodiment, the central shaft member 949′ is arranged to be selectively driven into rotation about the central longitudinal axis L′ by an operatively associated prime mover coupled with the central shaft member.

In another example embodiment, the central shaft member 949′ is arranged to be selectively driven into rotation about the central longitudinal axis L′ by one or more operatively associated prime movers coupled with a corresponding one or more of the plurality of blade members.

The example embodiments of the claimed invention are not limited to helicopters or to any particular rotary wing vehicles or to any particular application or applications. They can be employed on any system that involves blades moving through a fluid, such as wind turbines, river turbines, slow turning propellers, etc. It is to be understood that other embodiments will be utilized and structural and functional changes will be made without departing from the scope of the present invention. For example, the be driven by any moving fluid such as water or air such as in wind or river turbines, and they may equivalently be used to drive any fluid into motion such as in helicopter or other flight applications. The foregoing descriptions of embodiments of the present invention have been presented for the purposes of illustration and description. It is not intended to be exhaustive or to limit the embodiments of the claimed invention to the precise forms disclosed. Accordingly, many modifications and variations are possible in light of the above teachings. It is therefore intended that the scope of the invention be not limited in any way by this detailed description.

It is now claimed:

1. A rotor system 100 for lifting an associated load-carrying vehicle 109 upwardly, the rotor system 100 comprising:
a trackway 130 defining a continuous travel circuit 132;
a truck member 104 operatively coupled with the trackway 130, the truck member 104 being selectively translatable along the travel circuit 132;
a prime mover 217 operatively coupled with the truck member 104, the prime mover 217 selectively moving the truck member 104 along the travel circuit 132;
an elongate rotor blade 102 having a proximal end 140 operatively coupled with the truck member 104 and an opposite free distal end 142, wherein the rotor blade 102 is carried with the truck member 104 along the travel circuit 132 thereby generating an upward force F for lifting the associated load-carrying vehicle 109.

2. The rotor system 100 according to claim 1, further comprising:
a position sensor 231 configured to generate a signal representative of a position of the truck member 104 relative to the trackway 130; and,
a controller 119 configured to receive the signal representative of the position of the truck member 104 relative to the trackway 130 and to determine a position of the truck member 104 relative to the continuous travel circuit 132.

3. The rotor system according to claim 2, wherein:
the controller is configured to generate a motion control signal based on the determined position of the truck member relative to the continuous travel circuit; and,
the prime mover is responsive to the motion control signal to selectively move the truck member along the travel circuit.

4. The rotor system according to claim 3, further comprising:
a plurality of truck members, each of the plurality of truck members being operatively coupled with the trackway and each of the plurality of truck members being selectively translatable along the travel circuit;
a plurality of prime movers, each of the plurality of prime movers being operatively coupled with a corresponding one of the plurality of truck members, and each of the plurality of prime movers selectively moving a corresponding one of the plurality of truck members along the travel circuit responsive to the motion control signal; and,
a plurality of elongate rotor blades, each of the plurality of elongate rotor blades having a proximal end operatively coupled with a corresponding one of the plurality of truck members and an opposite free distal end, wherein each of the plurality of elongate rotor blades is carried with the corresponding one of the plurality of truck members along the travel circuit thereby generating the upward force for lifting the associated load-carrying vehicle.

5. The rotor system according to claim 4, further comprising:
a plurality of elongate spar members, each of the plurality of elongate spar members being operatively coupled with a corresponding one of the plurality of truck members and extending radially outwardly relative to the trackway, each of the plurality of elongate spar members carrying a one of the plurality of elongate rotor blades thereon in selected movable positions relative to the corresponding one of the plurality of spar members.

6. The rotor system according to claim 5, further comprising:
a plurality of first positioners, each of the plurality of first positioners being operatively coupled between a one of the plurality of elongate spar members and a one of the plurality of rotor blades, wherein each of the plurality of first positioners is responsive to a corresponding pitch control signal received from the controller to establish relative movement between a corresponding one of the rotor blades and a corresponding one of the spar members.

7. The rotor system according to claim 6, wherein:
each of the plurality of elongate spar members defines a longitudinal axis therealong extending radially outwardly relative to the trackway; and,
each of the rotor blades is operatively coupled with a corresponding one of the plurality of elongate spar members and is configured to selectively rotate about the longitudinal axis of the corresponding spar member carrying the rotor blade in response to the corresponding pitch control signal.

8. The rotor system according to claim 7, further comprising:
a plurality of sensor devices disposed in corresponding ones of the plurality of rotor blades, each of the plurality of sensor devices generating a rotor blade parameter feedback signal representative of a selected parameter of the corresponding rotor blade.

9. The rotor system according to claim 8, wherein:
the plurality of truck members comprises n truck members, wherein n≧1;
the plurality of prime movers comprises n prime movers;
the plurality of elongate rotor blades comprises n rotor blades;
the plurality of elongate spar members comprises n spar members;
the plurality of sensor devices comprises n sensor devices generating n rotor blade parameter feedback signals;
the controller is configured to generate n pitch control signals for delivery to the n prime movers for moving the n rotor blades relative to the n spar members in accordance with a predetermined control scheme; and,
the controller is configured to generate an i^{th} one of the 1-n control signals for controlling a position of the i^{th} rotor blade in accordance with the rotor blade parameter feedback signals of two or more sensor devices on two or more rotor blades immediately adjacent to the i^{th} rotor blade.

10. The rotor system according to claim 5, wherein:
each of the plurality of elongate rotor blades comprises a set of rotor blade segments extending end to end along a corresponding spar member thereof, wherein each rotor blade segment of the set of rotor blade segments is carried on the corresponding spar member thereof in selected movable positions relative to the corresponding spar members.

11. The rotor system according to claim 10, further comprising:
a plurality of sets of positioners, each set of the plurality of sets of positioners being disposed on a corresponding one of the plurality of elongate spar members, wherein each of the sets of positioners is operatively coupled between a one of the plurality of rotor blade segments of the sets of rotor blade segments and a corresponding elongate spar member carrying the set of rotor blade segments.

12. The rotor system according to claim 11, wherein:
the plurality of sets of positioners are individually responsive to rotor segment pitch control signals received from the controller for moving the plurality of rotor blade segments of the sets of rotor blade segments to selected positions relative to corresponding ones of the plurality of elongate spar members.

13. The rotor system according to claim 4, wherein the trackway is a circular trackway.

14. The rotor system according to claim 4, wherein the trackway is a non-circular trackway.

15. The rotor system according to claim 4, wherein:
the position sensor comprises:
a set of first sensor devices disposed in a predetermined spaced apart relationship relative to the trackway; and
a set of second sensor devices carried by the plurality of truck members; and,
the controller is configured to receive signals from the sets of first a second sensor devices and to generate the position control signals for each of the plurality of prime movers.

16. A rotor system (900′) for lifting an associate load-carrying vehicle (109′) upwardly, the rotor system comprising:
an elongate central shaft member (949′) defining a central longitudinal axis (L′) therealong;
a ring-shaped beam member (950′) operatively coupled with the central shaft member (949′) and being disposed in a plane substantially perpendicular to the central longitudinal axis (L′); and,
a plurality of elongate blade members (960a′-960j′) each having a proximal end operatively coupled with the ring-shaped beam member (950′) and an opposite free distal end;
wherein the central shaft member (949′) is arranged to be selectively driven into rotation about the central longitudinal axis (L′) whereby the plurality of blade members (960a′-960j′) coupled with the ring-shaped beam member (950′) are urged into motion along a circular path thereby generating an upward force (F′) for lifting the associated load-carrying vehicle (109′).

17. The rotor system according to claim 16, wherein:
the central shaft member (949′) is arranged to be selectively driven into rotation about the central longitudinal axis (L′) by an operatively associated prime mover coupled with the central shaft member.

18. The rotor system according to claim 16, wherein:
the central shaft member (949′) is arranged to be selectively driven into rotation about the central longitudinal axis (L′) by one or more operatively associated prime movers coupled with a corresponding one or more of the plurality of blade members.

19. The rotor system according to claim 16, wherein:
each of the plurality of elongate rotor blade members (960a′-960j′) comprises a set of rotor blade segments extending end to end along a corresponding spar member thereof, wherein each rotor blade segment of the set of rotor blade segments is carried on the corresponding spar member thereof in selected movable positions relative to the corresponding spar members.

20. The rotor system according to claim 19, further comprising:
a plurality of sets of positioners, each set of the plurality of sets of positioners being disposed on a corresponding one of the plurality of elongate spar members, wherein each of the sets of positioners is operatively coupled between a one of the plurality of rotor blade segments of the sets of rotor blade segments and a corresponding elongate spar member carrying the set of rotor blade segments.

21. The rotor system according to claim 20, wherein:
the plurality of sets of positioners are individually responsive to rotor segment pitch control signals received from the controller for moving the plurality of rotor blade segments of the sets of rotor blade segments to selected positions relative to corresponding ones of the plurality of elongate spar members.

22. A rotor system (900″) for an associated fluid driven turbine system, the rotor system comprising:
an elongate central shaft member (949″) defining a central longitudinal axis (L″) therealong;
a ring-shaped beam member (950″) operatively coupled with the central shaft member (949″) and being disposed in a plane substantially perpendicular to the central longitudinal axis (L″); and,
a plurality of elongate blade members (960a″-960j″) each having a proximal end operatively coupled with the ring-shaped beam member (950″) and an opposite free distal end;
wherein the central shaft member (949″) is arranged to be selectively driven into rotation about the central longitudinal axis (L″) whereby the plurality of blade members (960a″-960j″) coupled with the ring-shaped beam member (950″) are urged into motion along a circular path by a flow of an associated fluid thereover thereby generating a rotational force in the central shaft member (949″) for driving the associated fluid driven turbine system.
